(19) United States
(12) Patent Application Publication
(10) Pub. No.: US 2020/0191694 A1
(43) Pub. Date: Jun. 18, 2020

(54) SYSTEM FOR NEAR INFRARED ANALYSIS OF PARTICLE CHARACTERISTICS IN PARTICLE GRINDING OPERATIONS

(71) Applicants: JOSHUA TRACY, HARRISBURG, SD (US); ALEX PEARSON, SIOUX FALLS, SD (US); ROY OLSON, SIOUX FALLS, SD (US)

(72) Inventors: JOSHUA TRACY, HARRISBURG, SD (US); ALEX PEARSON, SIOUX FALLS, SD (US); ROY OLSON, SIOUX FALLS, SD (US)

(21) Appl. No.: 16/380,408

(22) Filed: Apr. 10, 2019

Related U.S. Application Data
(60) Provisional application No. 62/657,040, filed on Apr. 13, 2018.

(51) Int. Cl. G01N 15/02; B02C 25/00

(52) U.S. Cl. CPC G01N 15/0205; G01N 2015/0065; B02C 25/00

(57) ABSTRACT

A system for grinding particles has an input and an output and a particle flow path between the input and the output for a particle flow. The system may include a milling apparatus configured to grind particles of the particle flow moving along the particle flow path to produce ground particles for the particle flow, and the milling apparatus being configured to reduce a size of the particles of the particle flow. The system may also include a sensor assembly configured to sense at least one characteristic of particles moving along the particle flow path, the sensor assembly utilizing near infrared (NIR) energy to sense the at least one characteristic of particles moving along the particle flow path.

### REFERENCE TO RELATED APPLICATIONS

This application claims the benefit of U.S. Provisional Patent Application No. 62/657,040, filed Apr. 13, 2018, which is hereby incorporated by reference in its entirety.

### BACKGROUND

### Field

The present disclosure relates to particle grinding and milling and more particularly pertains to a new system for near infrared analysis of particle characteristics in particle grinding operations.

### SUMMARY

In one aspect, the present disclosure relates to a system for grinding particles which has an input and an output and defines a particle flow path between the input and the output for a particle flow between the input and output. The system may comprise a milling apparatus configured to grind particles of the particle flow moving along the particle flow path to produce around particles for the particle flow, and the milling apparatus being configured to reduce a size of the particles of the particle flow. The system may also comprise a sensor assembly configured to sense at least one characteristic of particles moving along the particle flow path, and the sensor assembly may utilize near infrared (NIR) energy to sense the at least one characteristic of particles moving along the particle flow path.

In another aspect, the present disclosure relates to a system for grinding particles having an input and an output and defining a particle flow path between the input and the output for a particle flow between the input and output. The system may comprise a milling apparatus configured to grind particles of the particle flow moving along the particle flow path to produce ground particles for the particle flow of a reduced size, the milling apparatus has a mill inlet and a mill outlet. The system may further comprise a sensor assembly configured to sense at least one characteristic of particles moving along the particle flow path, the sensor assembly utilizing near infrared (NIR) energy to sense the at least one characteristic of particles moving along the particle flow path. The sensor assembly may include a first sensor positioned at a location in the particle flow path prior to the mill inlet of the milling apparatus to detect the at least one characteristic of un-milled particles moving along the particle flow path prior to passing through the milling apparatus. The sensor assembly may further include a second sensor positioned at a location in the particle flow path after the mill outlet of the milling apparatus to detect the at least one characteristic of milled particles moving along the particle flow path after passing through the milling apparatus.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components, and the particulars of the steps, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWING

The disclosure will be better understood and when consideration is given to the drawing and the detailed description which follows. Such description makes reference to the annexed drawing wherein:

FIG. 1 is a schematic diagram of a new system for near infrared analysis of particle characteristics in particle grinding operations according to the present disclosure.

FIG. 2 is a schematic diagram of a portion of the system showing an exemplary system for measuring particle characteristics, according to an illustrative embodiment.

FIG. 3 is a schematic flow diagram of various operational aspects of the system, according to an illustrative implementation.

FIG. 4 is a schematic diagram of another embodiment of the system for near infrared analysis of particle characteristics in particle grinding.

FIG. 5 is a schematic perspective view of an embodiment of the system generally corresponding to the embodiment depicted in the diagram of FIG. 4.

FIG. 6 is a schematic second perspective view of the embodiment of the system shown in FIG. 5, according to an illustrative embodiment.

FIG. 7 is a schematic side view of the embodiment of the system shown in FIG. 5 with panels removed to show detail, according to an illustrative embodiment.

FIG. 8 is a schematic perspective sectional view of an input portion of the system including the input into the particle flow path, according to an illustrative embodiment.

FIG. 9 is a schematic perspective sectional view of a portion of the system including a scalper apparatus and a feed control hopper, according to an illustrative embodiment.

FIG. 10 is a perspective sectional view of a portion of the system including a milling apparatus, according to an illustrative embodiment.

FIG. 11 is a perspective sectional view of an output portion of the system including the output of the particle flow path, according to an illustrative embodiment.

### DETAILED DESCRIPTION

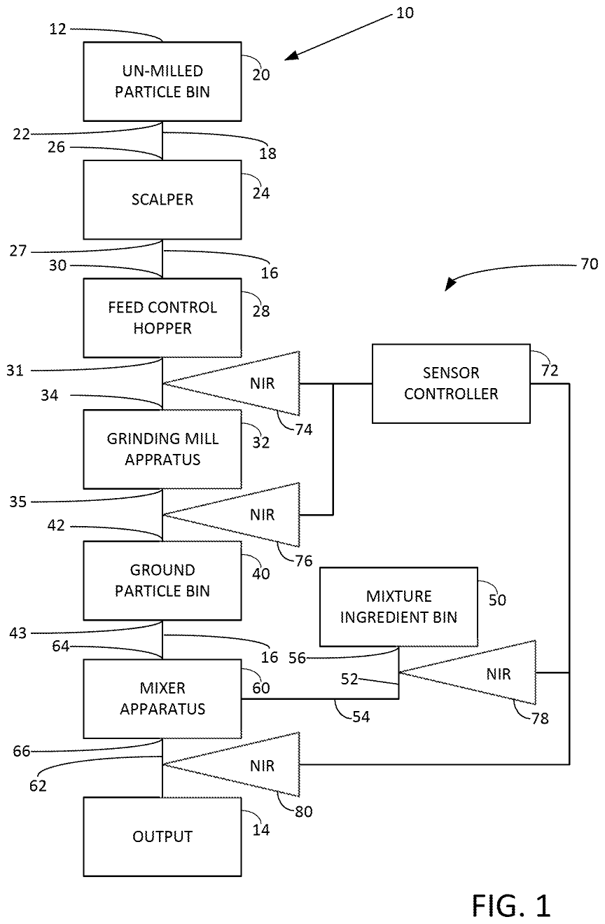

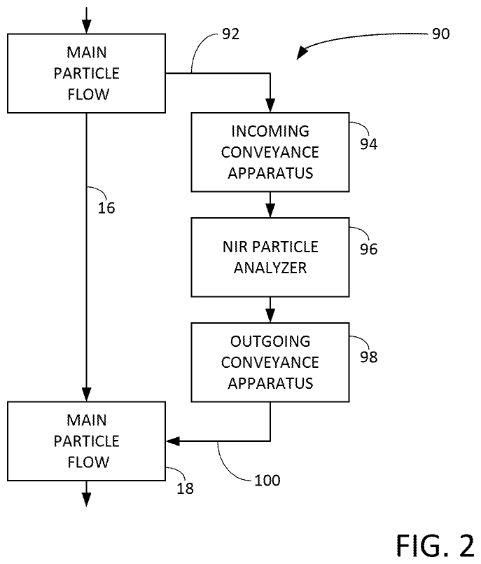

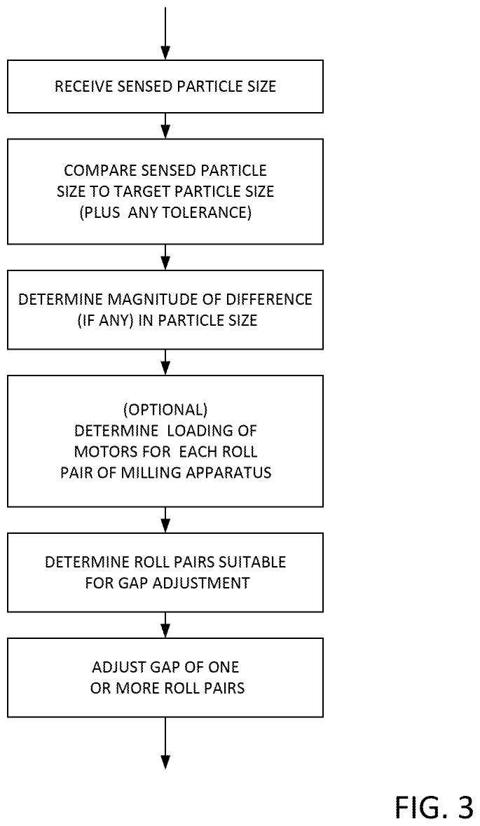

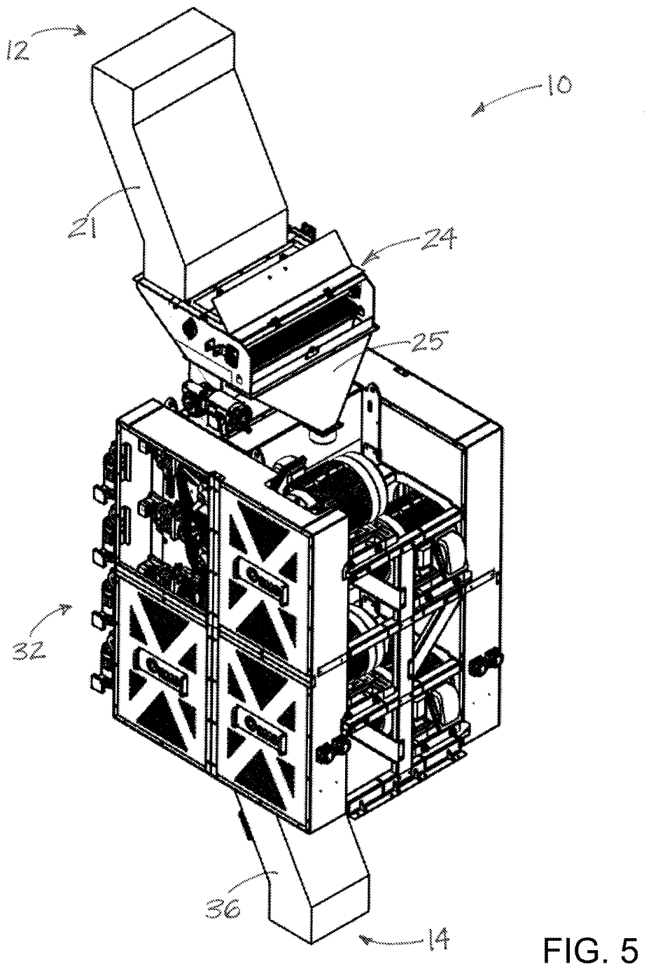

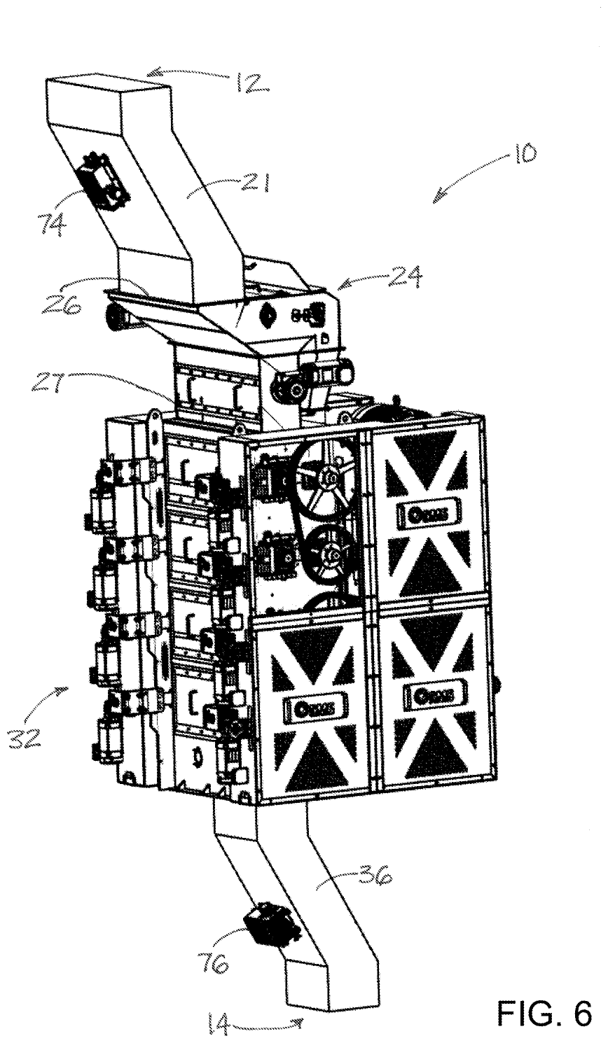

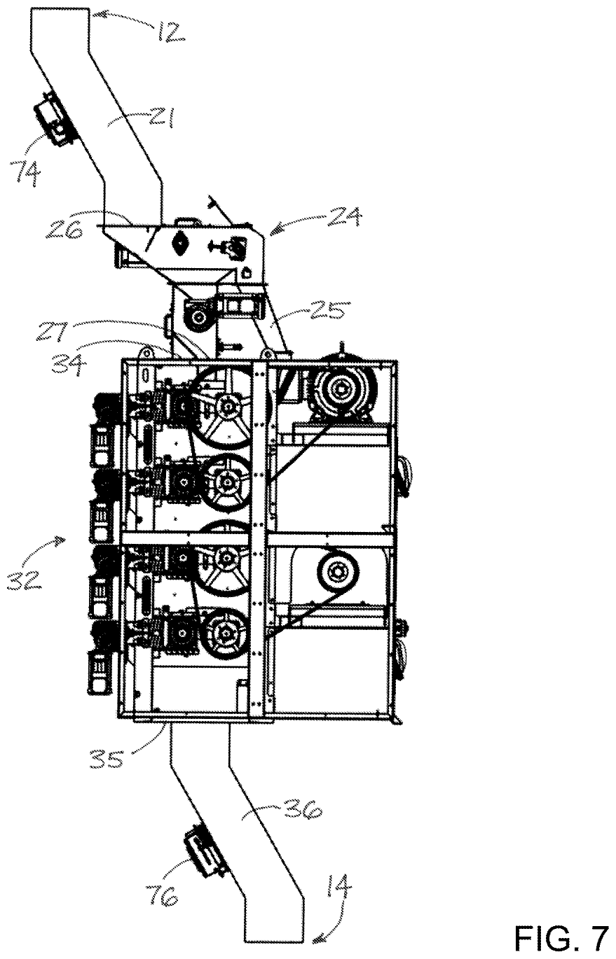

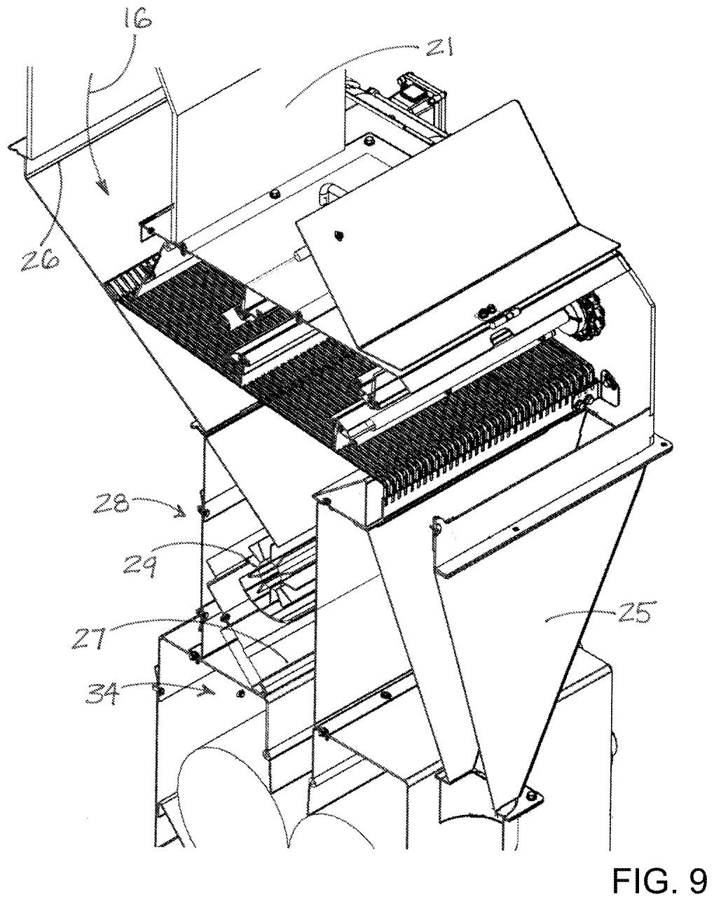

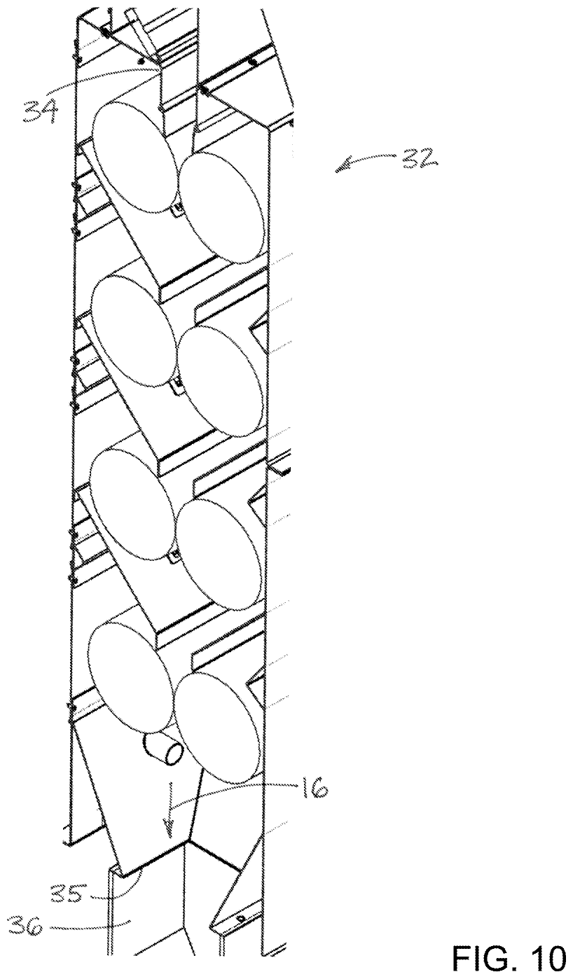

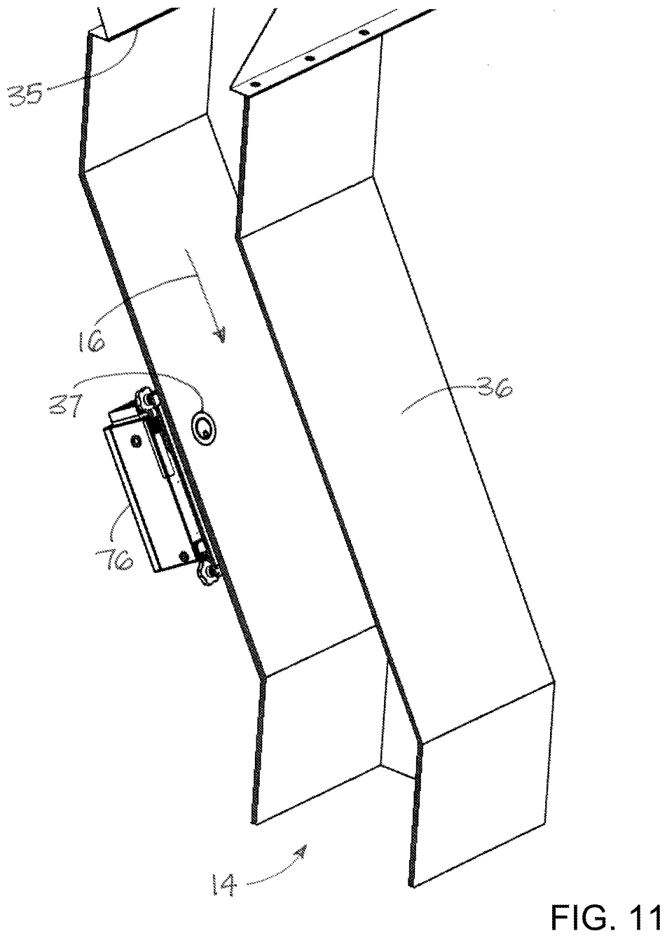

With reference now to the drawing, and in particular to FIGS. 1 through 11 thereof, a new system for near infrared analysis of particle characteristics in particle grinding operations embodying the principles and concepts of the disclosed subject matter will be described.

The applicants have recognized that many factors or characteristics may affect the efficacy of milling systems to produce ground particles with the desired size, uniformity, etc. in the most efficient manner. For example, information regarding the initial size of the particles may be used to adjust elements of the milling apparatus, as well as adjusting the rate at which the particles flow through the system and into the milling apparatus. Measurements of other characteristics, such as moisture content, fat content, and protein content may be utilized to adjust the operation of the system, as well as control the addition of any additional ingredients or substances to the particles as they move through the system. Accurate measurement of these characteristics is therefore important to the effective and efficient operation of the milling system in producing a useful and valuable product.

In one aspect of the disclosure, a system 10 will be described for processing particles between an input 12 and an output 14 of the system, and the processing typically involves the grinding or milling of the particles into smaller sizes such that the size characteristic of the particle at the output 14 is smaller than at the input 12. A particle flow path 16 is defined between the input 12 and output 14 for carrying a particle flow 18 therebetween, and suitable particle or material handling apparatus for causing such movement, such as augers or conveyors, are known. For the purposes of this description, the particles described are particles of grains, such as kernels or seeds, but it should be understood that the types of particles that may be processed by the system are not necessarily so limited. Moreover, the inclusion of various elements in this description of the system is optional.

The system 10 may include an un-milled particle bin 20 configured to hold a quantity of the particles to be milled prior to the actual milling of the particles. The un-milled particle bin 20 may be located on the particle flow path 16 toward the input 12 of the system, and the bin 20 may have a bin outlet 22 which is in communication with the flow path 16. In some embodiments, the system 10 may include a scalper apparatus 24 which is configured to remove foreign material from the particle flow path 16 which may contaminate the output product or may damage the apparatus of the system if allowed to continue along the particle flow path. The scalper apparatus 24 may be positioned along the flow path 16 after the un-milled particle bin 20 although other positions or locations in the path 16 may be utilized. The scalper apparatus 24 may have a scalper inlet 26 which is in communication with the bin outlet 22, and a scalper outlet 27 which continues the particle flow path 16.

The system may further include a feed control hopper 28 which is configured to control the rate of the particle flow 18 along at least a portion of the particle flow path 16. The feed control hopper 28 may be operated to vary the rate at which the particle flow continues along the flow path 16 based upon various conditions detected or sensed at locations downstream (or even upstream) of the feed control hopper. Illustratively, the feed control hopper may include a feed control rotor 29 may include a rotating shaft which is rotatably mounted on the feed apparatus housing 36 and a plurality of vanes which extend outwardly from the rotating shaft to rotate with the shaft with respect to the feed apparatus housing. The feed control hopper may have a hopper inlet 30 which is in communication with the scalper outlet 27, and may also have a hopper outlet 31 which continues the particle flow path between the input 12 and output 14.

A milling apparatus 32 of the system may be configured to grind particles of the particle flow 18 moving along the particle flow path 16 to produce ground particles of relatively smaller size (e.g. in at least one dimension) for the particle flow. In some embodiments, the milling apparatus 32 may include pairs of rolls between which the particles on the path 16 pass, and teeth on one or both of the rolls may function to grind the particles into the relatively smaller size. The milling apparatus 32 may have a mill inlet 34 which is in communication with the hopper outlet 31 of the feed control hopper, and a mill outlet 35 which continues the particle flow path 16.

The system may have an intermediate bin 40 for receiving the ground particles of the particle flow moving along the particle flow path from the milling apparatus 32. The intermediate bin 40 may collect a quantity of the ground particles to be, for example, dispensed from the system 10 or further processed as will be described below. The intermediate bin 40 may have an intermediate bin inlet 42 in communication with the mill outlet 35 of the milling apparatus 32, and may also have an intermediate bin outlet 43 which dispenses the ground particles from the system 10 or continues the particle flow path 16.

In some embodiments of the system, mixing of the ground particles with other substances or ingredients may be desired, and storage of such substances or ingredients prior to mixing with the ground particles of the particle flow 18 may be accomplished with one or more mixture ingredient bins 50. The bin or bins 50 may hold at least one mixture ingredient to be mixed with the ground particle flow. A mixture ingredient flow 52 may move along a mixture ingredient particle flow path 54 which originates from the mixture ingredient bin 50. The mixture ingredient bin 50 may have a mixture ingredient bin outlet 56 which is in communication with the mixture ingredient particle flow path 54 so that the contents of the bin 50 is able to exit the bin and move as a part of the mixture ingredient flow 52 through the flow path 54.

A mixing apparatus 60 may be configured to mix the ground particles of the particle flow 18 with the mixture ingredient or ingredients of the mixture ingredient flow 52 to create a particle mixture in a particle mixture flow 62 which originates from the mixing apparatus 60. The mixing apparatus 60 may have a mixer inlet 64 which is in communication with the intermediate bin outlet 43, and may also have a mixer outlet 65 which continues the particle flow path carrying the mixture particle flow 62. The mixer outlet 65 may be in communication with the output 14 of the system if the system is not designed to perform any further processing.

The system 10 may also include a sensor assembly 70 which is configured to sense at least one characteristic of particles moving along the particle flow path 16. The sensor assembly 70 may include one or more sensors, and the sensor or sensors may be configured to sense or detect a characteristic or characteristics of the particles moving past the sensor on the particle flow path 16. It will be recognized that not all systems will include all of the sensors described herein. A sensor controller 72 may be utilized to control operation of the various sensors as well as collect signals representing various characteristics of the particle flow for further utilization by the system and/or the operator of the system.

Advantageously, the sensors of the sensor assembly 70 may utilize near infrared (NIR) energy to sense the characteristic of characteristics of the particles in the particle flow 18 moving along the particle flow path. Exemplary characteristics measured by the NIR sensor is the size of the particles or some measurement representative of the size of the particles, the fat content of the particles, the moisture content of the particles, the protein content of the particles, and in some applications the composition of the mixture of the mixture particle flow. The sensor assembly may also be configured to detect the completeness or incompleteness of the mixing of the particles in the mixture particle flow.

In greater detail, the sensor assembly 70 may include a first sensor 74 which is configured to detect one or more characteristics of the un-milled particles moving along the particle flow path 16. The first sensor 74 may be positioned at a location prior to the milling apparatus 32 along the flow path 16, and may be positioned at a location after the un-milled particle bin 20. The first sensor 74 may be configured to sense the particle size of the un-milled particles, which may be utilized in configuring or setting the rolls of the milling apparatus, such as the spacing between the rolls. The first sensor 74 may also sense the fat content, protein content, and moisture content of the un-milled particles.

The sensor assembly 70 may also include a second sensor 76 which is configured to detect one or more characteristics of the milled particles moving along the particle flow path 16 after having passed through the milling apparatus. The second sensor 76 may be positioned at a location after the milling apparatus along the particle flow path, and may be located before the intermediate bin 40 along the flow path. The second sensor 76 may be configured to sense the particle size of the milled particles, which may be useful in setting or resetting the position of the rolls of the milling apparatus with respect to each other, particularly if the size of the particles is not of the desired size or uniformity. The second sensor 76 may also be utilized to sense fat, protein, and moisture content of the milled particles.

A third sensor 78 may be utilized to sense or detect a characteristic or characteristics of the mixture ingredient or ingredients of the mixture ingredient flow 52 along the mixture ingredient particle flow path 54. The third sensor 78 may be positioned after the mixture ingredient bin 50 along the mixture ingredient particle flow path 54 and may be positioned at a location prior to the mixing apparatus 60 in the flow path 54. The third sensor 78 may be configured to sense the particle size of the mixture ingredient or ingredients, as well as fat, protein, and moisture content of the same.

A fourth sensor 80 may be configured to detect one or more characteristics of the particle mixture of the mixture particle flow 62 along the flow path 16. The fourth sensor 80 may be positioned at a location after the mixer apparatus 60 along the flow path 16 and may be positioned at a location that is prior to the output 14 of the system. The fourth sensor 80 may be configured to sense the particle size of the particle mixture, as well as the fat, protein, and moisture content of the particle mixture. Furthermore, the fourth sensor may be utilized to sense the composition of the particle mixture exiting the mixing apparatus which may be useful for adjusting the mixing apparatus to increase or decrease the level of the mixture ingredient or ingredients in the particle mixture to be output.

One or more of the sensor assemblies 70 may include a system 90 for sampling and analyzing particles taken from the main particle flow 16 on the main particle flow path 16. A portion of the main particle flow may be diverted from the particle flow path 16 to a sampled particle path 92 which may include an incoming conveyance apparatus 94 for drawing a sampled particle flow from the main particle flow at a suitable location along the particle flow path 16. The sampled particle flow may be directed into a NIR particle analyzer 96 which may utilized near infrared energy to measure various characteristics of the particles comprising the sampled particle flow, such as the size of particles in the sampled particle flow. The sampled particle flow may then be returned to the main particle flow 18 along a return particle path 100 by an outgoing conveyance apparatus 98. Optionally, the particles exiting the NIR particle analyzer 96 could be discarded and not returned to the main particle flow 18.

In operation, prior to an initial sensing of the particle characteristics by the sensor assembly, the outgoing conveyance apparatus 98 may be operated to clear any particles from prior operation from the NIR particle analyzer 96. After sufficient operation of the outgoing conveyance apparatus to clear particles from the NIR particle analyzer 96, the incoming conveyance apparatus 94 may be operated to initiate the drawing of the sampled particle flow from the main particle flow to feed into the NIR particle analyzer 96 so that readings of particle characteristics, such as particle size, may be conducted by the analyzer 96.

Aspects of the system 10 may be adjusted or varied based upon one or more readings or signals provided by the NIR particle analyzer 96. Illustratively, a particle size reading by the analyzer 96 may be compared to a target particle size and any particle size tolerance input into the system, such as by the operator of the system. For example, based upon the output of the particle analyzer 96, the system may determine if the particle size reading is greater than the target particle size plus any particle size tolerance, or if the particle size reading is less than the target particle size minus any particle size tolerance, or if the particle size reading is within the acceptable particle size tolerance of the target particle size.

If the particle size reading is greater than the target particle size plus any size tolerance, then, for example, an adjustment of the gap or separation between the grinding rolls of the milling apparatus 32 may be initiated. In some implementations, a determination may be made as to the degree to which the sensed particle size exceeds, or falls short of, the target particle size, and based upon the magnitude of the difference between the particle size reading and the target particle size, either a relatively large adjustment, a relatively small adjustment, or a relatively medial adjustment, medial adjustment of the gap may be initiated. As will be recognized by those in the art, the adjustment of the gap may be accomplished by the movement of a movable roll of the pair of rolls with respect to the roll supporting frame while a stationary roll of the pair of rolls remains stationary with respect to the supporting frame.

In the case of milling apparatus having more than one pair of grinding rolls, prior to the adjustment of the position of any rolls, a determination may be made regarding the relative load on the motors each driving a pair of the rolls. More specifically, for each motor, a determination may be made regarding the power consumption of the motor with respect to a suitable tolerance range for the motor's power consumption (such as a predetermined tolerance). If the power consumption, e.g. amperage drawn, by a motor is less than the suitable tolerance range, the system may designate the rolls associated with that motor (or motors) as being suitable for adjustment. Conversely, motors with power consumption that is within the tolerance range or above the tolerance range may not have the associated rolls designated as being suitable for adjustment.

Based upon the determination of the magnitude of the difference between the sensed particle size and the target particle size, and the corresponding suitable degree of roll position adjustment (e.g. relatively large, relatively small or relatively medial), the gap between the rolls may be adjusted by a relatively large amount, a relatively small amount, or a relatively medial amount. For milling apparatus having multiple pairs of rolls, the adjustment of the gap may be limited to one or more of the pairs of rolls that have been determined to be suitable for adjustment (e.g. rolls associated with motors having a power consumption level that is at or below the suitable tolerance range for the motor). Illustratively, when the detected particle size exceeds the target particle size (plus any tolerance), the gap between a pair of rolls may be reduced a relatively large amount, a relatively small amount, or relatively medial amount depending upon the relative magnitude that the detected particle size exceeds the target particle size (plus any tolerance). Conversely, when the detected particle size is less than the target particle size (less any tolerance), the gap between a pair of rolls may be increased a relatively large amount, relatively small amount, or relatively medial amount depending upon the relative magnitude that the detected particle size fall short of the targeted particle size (less any tolerance). The actual magnitude of “relatively large,” “relatively small,” and “relatively medial” will typically vary depending upon the initial and final particle sizes, the type of particles being mailed, as well as other factors known to those skilled in the art.

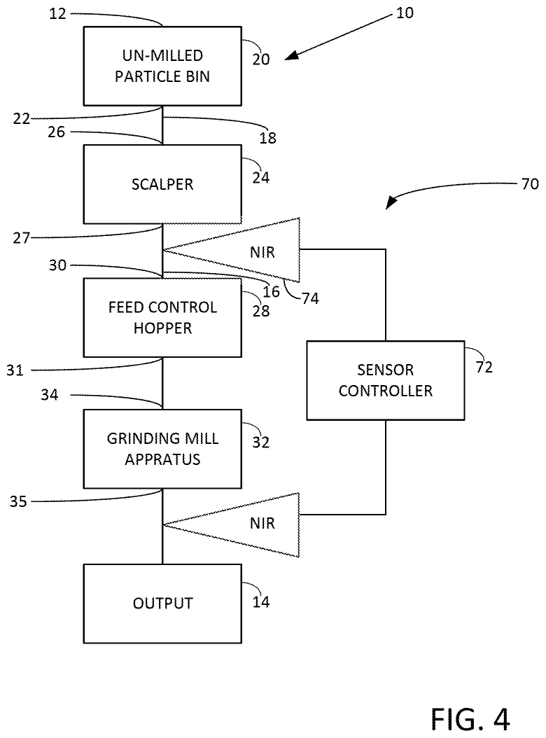

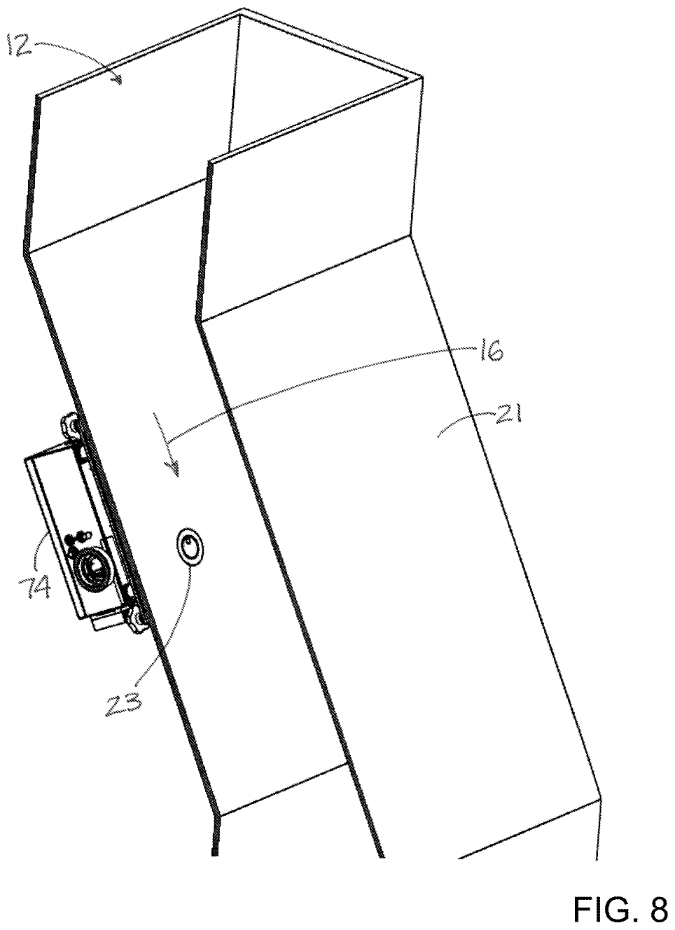

FIGS. 4 through 11 of the drawings illustrate embodiments of the system 10 having various features of the disclosure. In particular, the embodiments include an un-milled particle bin 20 or input duct 21 at the input 12 of the system to form an input portion of the particle flow path 16 for receiving un-milled and relatively unprocessed particles. Illustratively, the first sensor 74 may be associated with the input duct 21 to sense characteristics of the particles moving through the input portion of the particle flow path. The sensor 74 may sense the particles through an opening in a wall of the input duct 21, and a window into the interior of the duct that passes being radiating from the sensor 74. Illustratively, the window may be formed by a sapphire material which covers the wall opening. Preferably, the wall opening and the window are positioned on the input duct in a manner so that at least some of the particles of the particle flow 18 move over the window and through the beam emitted by the sensor 74. As shown, for example, in FIG. 8, the extent of the duct may be inclined or tilted to encourage movement of particles over the window and proximate to the wall opening through which the sensor 74 senses particle characteristics.

The scalper apparatus 24 may receive particles from the input duct 21 of the input portion into the scalper inlet 26 with the particles suitable for further milling passing through the scalper outlet 27, while trash and other debris may be passed out of the discard outlet 25 of the scalper for disposal. The milling apparatus 32 may have multiple stages or pairs of mill rolls between the mill inlet 34 and the mill outlet 35 for progressively grinding the particles into finer pieces.

An output duct 36 may be in communication with the mill outlet 35 for receiving the ground or milled particles from the milling apparatus 32. In some embodiments, the output duct 36 may have a similar configuration to the input duct 21 from the milling apparatus 32, and may include a wall opening in the duct 36 which is covered by a window 37 which permits the radiation of the second sensor 76 to pass through the window and says the characteristics of the milled particles passing through the interior of the output duct 36.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A system for grinding particles having an input and an output and defining a particle flow path between the input and the output for a particle flow between the input and output, the system comprising:
a milling apparatus configured to grind particles of the particle flow moving along the particle flow path to produce ground particles for the particle flow_{;} the milling apparatus being configured to reduce a size of the particles of the particle flow; and
a sensor assembly configured to sense at least one characteristic of particles moving along the particle flow path, the sensor assembly utilizing near infrared (NIR) energy to sense the at least one characteristic of particles moving along the particle flow path.

2. The system of claim 1 wherein the at least one characteristic of the particles sensed by the sensor assembly comprises a particle size of the particles in the particle flow through the system.

3. The system of claim I wherein the at least one characteristic of the particles sensed by the sensor assembly comprises a characteristic selected from the group of characteristics consisting of a fat content, a moisture content, and a protein content.

4. The system of claim 1 wherein the sensor assembly comprises a first sensor configured to detect the at least one characteristic of un-milled particles moving along the particle flow path prior to passing through the milling apparatus.

5. The system of claim 4 wherein the milling apparatus has a mill inlet and a mill outlet, the first sensor being positioned at a location in the particle flow path prior to the mill inlet of the milling apparatus.

6. The system of claim 1 wherein the sensor assembly comprises a second sensor which is configured to detect the at least one characteristic of milled particles moving along the particle flow path after passing through the milling apparatus.

7. The system of claim 6 wherein the milling apparatus has a mill inlet and a mill outlet, the second sensor being positioned at a location in the particle flow path after the mill outlet of the milling apparatus.

8. The system of claim 1 additionally comprising a scalper apparatus configured to remove foreign material from the particle flow path, the scalper apparatus being positioned along the particle flow path prior to the milling apparatus.

9. The system of claim 1 additionally comprising a feed control hopper configured to control a rate of the particle flow along at least a portion of the particle flow path, the feed control hopper being positioned along the particle flow path prior to the milling apparatus

10. The system of claim 1 additionally comprising a mixing apparatus configured to mix ground particles passing out of the milling apparatus along the particle flow with at least one mixture ingredient to create a particle mixture.

11. The system of claim 10 additionally comprising a mixture ingredient bin configured to hold at least one mixture ingredient for mixing by the mixing apparatus with the ground particle flow along the particle flow path.

12. The system of claim 11 wherein a mixture ingredient flow along a mixture ingredient particle flow path originates from the mixture ingredients bin; and
wherein the sensor assembly comprises a third sensor configured to detect the at least one characteristic of the at least one mixture ingredient of the mixture ingredient flow along the mixture ingredient particle flow path.

13. The system of claim 10 wherein a mixture particle flow along the particle flow path originates from the mixing apparatus, and
wherein the sensor assembly comprises a fourth sensor configured to detect the at least one characteristic of the particle mixture along the particle flow path, the fourth sensor being positioned at a location after the mixer apparatus along the particle flow path.

14. A system for grinding particles having an input and an output and defining a particle flow path between the input and the output for a particle flow between the input and output, the system comprising:
a milling apparatus configured to grind particles of the particle flow moving along the particle flow path to produce ground particles for the particle flow of a reduced size, the milling apparatus has a mill inlet and a mill outlet; and
a sensor assembly configured to sense at least one characteristic of particles moving along the particle flow path, the sensor assembly utilizing near infrared (NIR) energy to sense the at least one characteristic of particles moving along the particle flow path, the sensor assembly including:
a first sensor positioned at a location in the particle flow path prior to the mill inlet of the milling apparatus to detect the at least one characteristic of un-milled particles moving along the particle flow path prior to passing through the milling apparatus; and
a second sensor positioned at a location in the particle flow path after the mill outlet of the milling apparatus to detect the at least one characteristic of milled particles moving along the particle flow path after passing through the milling apparatus.

15. The system of claim 14 wherein the at least one characteristic of the particles sensed by the sensor assembly comprises a particle size of the particles in the particle flow through the system.

16. The system of claim 1 wherein the at least one characteristic of the particles sensed by the sensor assembly comprises a characteristic selected from the group of characteristics consisting of a fat content, a moisture content, and a protein content.

17. The system of claim 14 additionally comprising a scalper apparatus positioned along the particle flow path prior to the milling apparatus to remove foreign material from the particle flow path.

18. The system of claim 1 additionally comprising a feed control hopper positioned along the particle flow path prior to the milling apparatus to control a rate of the particle flow along at least a portion of the particle flow path.
